(19) United States
(12) Patent Application Publication
(10) Pub. No.: US 2026/0181553 A1
(43) Pub. Date: Jun. 25, 2026

(54) WAKE UP SIGNAL RANGE EXTENSION

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Jelena DAMNJANOVIC, Del Mar, CA (US); Junyi LI, Greentown, PA (US); Tao LUO, San Diego, CA (US)

(21) Appl. No.: 19/001,200

(22) Filed: Dec. 24, 2024

(51) Int. Cl. H04W 52/02; H04W 88/04

(52) U.S. Cl. CPC H04W 52/0235; H04W 88/04

(57) ABSTRACT

Methods, systems, and devices for wireless communications are described in which a first user equipment (UE) may relay a wake up signal (WUS) for a second UE. A WUS may be modulated using on-off keying. The first UE may be within the WUS range of the network entity while the second UE may be outside of the WUS range. The network entity may indicate to the first UE to relay WUSs that include the identifier for the second UE. The first UE may receive and relay the WUS intended for the second UE via a lower power transceiver of the first UE. The first UE may relay WUSs while in a reduced power mode. The second UE may receive the relayed WUS via a lower power transceiver of the second UE and may wake a primary transceiver of the second UE in response to the WUS.

### FIELD OF TECHNOLOGY

The following relates to wireless communications, including wake up signal range extension.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first user equipment (UE) is described. The method may include receiving, at the first UE, control signaling that indicates for the first UE to relay one or more wake up signals (WUSs) that each include an identifier associated with a second UE, receiving, at the first UE, a WUS that includes the identifier associated with the second UE, where the WUS is modulated in accordance with an on-off keying (OOK) modulation scheme, and relaying, by the first UE, the WUS to the second UE based on the control signaling and based on the WUS including the identifier associated with the second UE.

A first UE for wireless communications is described. The first UE may include one or more memories storing processor-executable code, one or more transceivers, and one or more processors coupled with the one or more memories and the one or more transceivers. The one or more processors may be configured to receive, at the first UE via the one or more transceivers, control signaling that indicates for the first UE to relay one or more WUSs that each include an identifier associated with a second UE, receive, via the one or more transceivers and at the first UE, a WUS that includes the identifier associated with the second UE, where the WUS is modulated in accordance with an OOK modulation scheme, and relay, via the one or more transceivers and by the first UE, the WUS to the second UE based on the control signaling and based on the WUS including the identifier associated with the second UE.

Another first UE for wireless communications is described. The first UE may include means for receiving, at the first UE, control signaling that indicates for the first UE to relay one or more WUSs that each include an identifier associated with a second UE, means for receiving, at the first UE, a WUS that includes the identifier associated with the second UE, where the WUS is modulated in accordance with an OOK modulation scheme, and means for relaying, by the first UE, the WUS to the second UE based on the control signaling and based on the WUS including the identifier associated with the second UE.

A non-transitory computer-readable medium storing code for wireless communications is described. The code may include instructions executable by one or more processors to receive, at the first UE, control signaling that indicates for the first UE to relay one or more WUSs that each include an identifier associated with a second UE, receive, at the first UE, a WUS that includes the identifier associated with the second UE, where the WUS is modulated in accordance with an OOK modulation scheme, and relay, by the first UE, the WUS to the second UE based on the control signaling and based on the WUS including the identifier associated with the second UE.

In some examples of the method, first UEs, and non-transitory computer-readable medium described herein, the first UE receives the WUS and relays the WUS via a secondary transceiver of the first UE while a primary transceiver of the first UE may be in a sleep mode.

Some examples of the method, first UEs, and non-transitory computer-readable medium described herein may further include operations, features, means, or instructions for receiving, from a network entity, scheduling information for a set of WUS monitoring occasions and a set of WUS relay occasions, where the WUS may be received via a WUS monitoring occasion of the set of WUS monitoring occasions, and where the WUS may be relayed via a WUS relay occasion of the set of WUS relay occasions.

Some examples of the method, first UEs, and non-transitory computer-readable medium described herein may further include operations, features, means, or instructions for receiving, via a second WUS monitoring occasion of the set of WUS monitoring occasions, a second WUS that includes a second identifier associated with the first UE, where the second WUS may be modulated in accordance with the OOK modulation scheme and performing a communication with the network entity based on reception of the second WUS.

Some examples of the method, first UEs, and non-transitory computer-readable medium described herein may further include operations, features, means, or instructions for receiving, prior to the reception of the second WUS, an indication of the second identifier associated with the first UE.

In some examples of the method, first UEs, and non-transitory computer-readable medium described herein, the first UE receives the second WUS via a secondary transceiver of the second UE while a primary transceiver of the first UE may be in a sleep mode and the method, apparatuses, and non-transitory computer-readable medium may include further operations, features, means, or instructions for transitioning the primary transceiver to an active mode based on the reception of the WUS, where the communication may be performed via the primary transceiver.

In some examples of the method, first UEs, and non-transitory computer-readable medium described herein, the scheduling information indicates a mapping between the set of WUS monitoring occasions and the set of WUS relay occasions.

In some examples of the method, first UEs, and non-transitory computer-readable medium described herein, the OOK modulation scheme may be one of OOK type one or OOK type four.

Some examples of the method, first UEs, and non-transitory computer-readable medium described herein may further include operations, features, means, or instructions for receiving a set of channel state information (CSI) reference signals (CSI-RSs) and transmitting a CSI report based on one or more measurements of the set of CSI-RSs, where reception of the control signaling may be based on the CSI report.

A method for wireless communications by a second UE is described. The method may include receiving, from a first UE, a WUS that includes an identifier associated with the second UE and that is a relayed signal from a network entity, where the WUS is modulated in accordance with an OOK modulation scheme and performing a communication with the network entity based on reception of the WUS.

A second UE for wireless communications is described. The second UE may include one or more memories storing processor-executable code, one or more transceivers, and one or more processors coupled with the one or more memories and the one or more transceivers. The one or more processors may be configured to receive, via the one or more transceivers and from a first UE, a WUS that includes an identifier associated with the second UE and that is a relayed signal from a network entity, where the WUS is modulated in accordance with an OOK modulation scheme and perform, via the one or more transceivers, a communication with the network entity based on reception of the WUS.

Another second UE for wireless communications is described. The second UE may include means for receiving, from a first UE, a WUS that includes an identifier associated with the second UE and that is a relayed signal from a network entity, where the WUS is modulated in accordance with an OOK modulation scheme and means for performing a communication with the network entity based on reception of the WUS.

A non-transitory computer-readable medium storing code for wireless communications is described. The code may include instructions executable by one or more processors to receive, from a first UE, a WUS that includes an identifier associated with the second UE and that is a relayed signal from a network entity, where the WUS is modulated in accordance with an OOK modulation scheme and perform a communication with the network entity based on reception of the WUS.

In some examples of the method, second UEs, and non-transitory computer-readable medium described herein, the second UE receives the WUS via a secondary transceiver of the second UE while a primary transceiver of the second UE may be in a sleep mode and the method, apparatuses, and non-transitory computer-readable medium may include further operations, features, means, or instructions for transitioning the primary transceiver to an active mode based on the reception of the WUS, where the communication may be performed via the primary transceiver.

Some examples of the method, second UEs, and non-transitory computer-readable medium described herein may further include operations, features, means, or instructions for receiving, from the network entity prior to the reception of the WUS, an indication of the identifier for the second UE.

In some examples of the method, second UEs, and non-transitory computer-readable medium described herein, performing the communication with the network entity may include operations, features, means, or instructions for receiving a physical downlink control channel communication.

Some examples of the method, second UEs, and non-transitory computer-readable medium described herein may further include operations, features, means, or instructions for receiving, from the network entity, scheduling information for a set of WUS monitoring occasions, where the WUS may be received via a WUS monitoring occasion of the set of WUS monitoring occasions.

Some examples of the method, second UEs, and non-transitory computer-readable medium described herein may further include operations, features, means, or instructions for receiving a set of CSI-RSs and transmitting a CSI report based on one or more measurements of the set of CSI-RSs, where the reception of the WUS from the first UE may be based on the CSI report.

In some examples of the method, second UEs, and non-transitory computer-readable medium described herein, the OOK modulation scheme may be one of OOK type one or OOK type four.

A method for wireless communications by a network entity is described. The method may include outputting, for a first UE, control signaling that indicates for the first UE to relay one or more WUSs that each include an identifier associated with a second UE and outputting, for relay by the first UE, a WUS that includes the identifier associated with the second UE, where the WUS is modulated in accordance with an OOK modulation scheme.

A network entity for wireless communications is described. The network entity may include one or more memories storing processor executable code, and one or more processors coupled with the one or more memories. The one or more processors may be configured to output, for a first UE, control signaling that indicates for the first UE to relay one or more WUSs that each include an identifier associated with a second UE and output, for relay by the first UE, a WUS that includes the identifier associated with the second UE, where the WUS is modulated in accordance with an OOK modulation scheme.

Another network entity for wireless communications is described. The network entity may include means for outputting, for a first UE, control signaling that indicates for the first UE to relay one or more WUSs that each include an identifier associated with a second UE and means for outputting, for relay by the first UE, a WUS that includes the identifier associated with the second UE, where the WUS is modulated in accordance with an OOK modulation scheme.

A non-transitory computer-readable medium storing code for wireless communications is described. The code may include instructions executable by one or more processors to output, for a first UE, control signaling that indicates for the first UE to relay one or more WUSs that each include an identifier associated with a second UE and output, for relay by the first UE, a WUS that includes the identifier associated with the second UE, where the WUS is modulated in accordance with an OOK modulation scheme.

Some examples of the method, network entities, and non-transitory computer-readable medium described herein may further include operations, features, means, or instructions for performing a communication with the second UE based on outputting the WUS.

In some examples of the method, network entities, and non-transitory computer-readable medium described herein, performing the communication may include operations, features, means, or instructions for outputting a physical downlink control channel communication for the second UE.

Some examples of the method, network entities, and non-transitory computer-readable medium described herein may further include operations, features, means, or instructions for outputting, for the first UE, first scheduling information for a first set of WUS monitoring occasions and a set of WUS relay occasions, where the WUS may be output via a WUS monitoring occasion of the first set of WUS monitoring occasions and outputting, for the second UE, second scheduling information for a second set of monitoring occasions that correspond to the set of WUS relay occasions.

Some examples of the method, network entities, and non-transitory computer-readable medium described herein may further include operations, features, means, or instructions for outputting, via a second WUS monitoring occasion of the first set of WUS monitoring occasions, a second WUS that includes a second identifier for the first UE, where the second WUS may be modulated in accordance with the OOK modulation scheme and performing a communication with the first UE based on outputting of the second WUS.

Some examples of the method, network entities, and non-transitory computer-readable medium described herein may further include operations, features, means, or instructions for outputting, for the first UE and prior to outputting of the second WUS, an indication of the second identifier associated with the first UE.

In some examples of the method, network entities, and non-transitory computer-readable medium described herein, the first scheduling information indicates a mapping between the first set of WUS monitoring occasions and the set of WUS relay occasions.

Some examples of the method, network entities, and non-transitory computer-readable medium described herein may further include operations, features, means, or instructions for outputting, for the second UE and prior to outputting of the WUS, an indication of the identifier associated with the second UE.

Some examples of the method, network entities, and non-transitory computer-readable medium described herein may further include operations, features, means, or instructions for outputting a first set of CSI-RSs for the first UE, obtaining a first CSI report associated with the first UE based on the first set of CSI-RSs, outputting a second set of CSI-RSs for the second UE, and obtaining a second CSI report associated with the second UE based on the second set of CSI-RSs, where outputting the control signaling may be based on the first CSI report and the second CSI report.

In some examples of the method, network entities, and non-transitory computer-readable medium described herein, the OOK modulation scheme may be one of OOK type one or OOK type four.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports wake up signal (WUS) range extension in accordance with one or more aspects of the present disclosure.

FIG. 2 shows an example of a timing diagram that supports WUS range extension in accordance with one or more aspects of the present disclosure.

FIG. 3 shows an example of a wireless communications system that supports WUS range extension in accordance with one or more aspects of the present disclosure.

FIG. 4 shows an example of a signaling diagram that supports WUS range extension in accordance with one or more aspects of the present disclosure.

FIG. 5 shows an example of a process flow that supports WUS range extension in accordance with one or more aspects of the present disclosure.

FIGS. 6 and 7 show block diagrams of devices that support WUS range extension in accordance with one or more aspects of the present disclosure.

FIG. 8 shows a block diagram of a communications manager that supports WUS range extension in accordance with one or more aspects of the present disclosure.

FIG. 9 shows a diagram of a system including a device that supports WUS range extension in accordance with one or more aspects of the present disclosure.

FIGS. 10 and 11 show block diagrams of devices that support WUS range extension in accordance with one or more aspects of the present disclosure.

FIG. 12 shows a block diagram of a communications manager that supports WUS range extension in accordance with one or more aspects of the present disclosure.

FIG. 13 shows a diagram of a system including a device that supports WUS range extension in accordance with one or more aspects of the present disclosure.

FIGS. 14 through 16 show flowcharts illustrating methods that support WUS range extension in accordance with one or more aspects of the present disclosure.

### DETAILED DESCRIPTION

Wireless networks may adopt various techniques and technologies to conserve power. One such example power saving technique may include use of a low-power wakeup radio (LP-WUR) at a user equipment (UE) that may be used in lieu of a main radio (MR) when the UE is in a lower power state, such as a sleep state. An LP-WUR may also be referred to as a low power or secondary transceiver. A main radio may also be referred to as a main or primary transceiver. The LP-WUR may be used to monitor for wake up signal (WUS) transmissions (e.g., low power WUSs (LP-WUSs)), low-power synchronization signal (LP-SS) transmissions, or both. An LP-SS transmission may be transmitted periodically by a network entity and may provide information for synchronization or timing of LP-SS and LP-WUS transmissions. An LP-WUS transmission may carry or otherwise convey an indication for the UE to transition to another state, such as a higher power state or an awake state, and power up the MR to perform wireless communications with a network. Such low-power (LP) signal transmissions (e.g., signal transmissions intended for reception by the LP-WUR) may use on-off keying (OOK) modulation for low-complexity envelope detection by the LP-WUR. An LP-WUR may be a low-complexity and low power radio that can detect an OOK LP-WUS and then cause the UE to turn on other components of the UE (e.g., a main radio and associated components) for subsequent communications.

For example, a network entity may transmit a WUS (e.g., an LP-WUS) to the UE when the network entity has data to communicate with the UE. The UE may activate the primary transceiver in response to the WUS to use for communication with the network entity. For example, after activating the primary transceiver, the UE may monitor for a physical downlink control channel (PDCCH) that may schedule additional communications with the network. WUSs may include identifiers for the UEs to indicate the intended UE, and such an identifier may be configured for a UE while the primary transceiver of the UE is in the awake or active mode. WUSs may have a shorter range than orthogonal frequency division multiplexing (OFDM) modulated signals as WUSs may use OOK modulation. Accordingly, a UE outside of the range of a WUS may not be able to transition the primary transceiver to the sleep mode as the UE may be unable to receive the WUS indicating to the wake the primary transceiver.

In some aspects, first UE may be configured to relay a WUS for a second UE. For example, the first UE may be within the WUS range of the network entity while the second UE may be outside of the WUS range of the network entity. In some examples, the network entity may determine whether a particular UE is within the WUS range of the network entity based on channel conditions indicated in channel state information (CSI) reports from the UEs. The network entity may indicate to the first UE to relay WUSs that include the identifier for the second UE. Accordingly, the second UE may save energy via transitioning the primary transceiver to the sleep mode even when the second UE is outside the WUS range of the network entity. In some examples, the first UE may receive and relay the WUS intended for the second UE via a secondary transceiver (e.g., the LP-WUR) of the first UE. Accordingly, the first UE may relay WUSs while in a reduced power mode (e.g., a sleep mode). The network entity may configure WUS monitoring occasions for the UEs. For example, the network entity may configure, for the first UE, WUS monitoring occasions and WUS relaying occasions. The network entity may configure WUS monitoring occasions for the second UE that correspond to the WUS relaying occasions. The first UE may determine whether to relay a particular WUS based on the UE identifier indicated in the WUS (e.g., whether the UE identifier indicates the WUS is intended for the first UE or the second UE).

Aspects of the disclosure are initially described in the context of wireless communications systems. Aspects of the disclosure are further illustrated by and described with reference to timing diagrams, signaling diagrams, process flows, apparatus diagrams, system diagrams, and flowcharts that relate to WUS range extension.

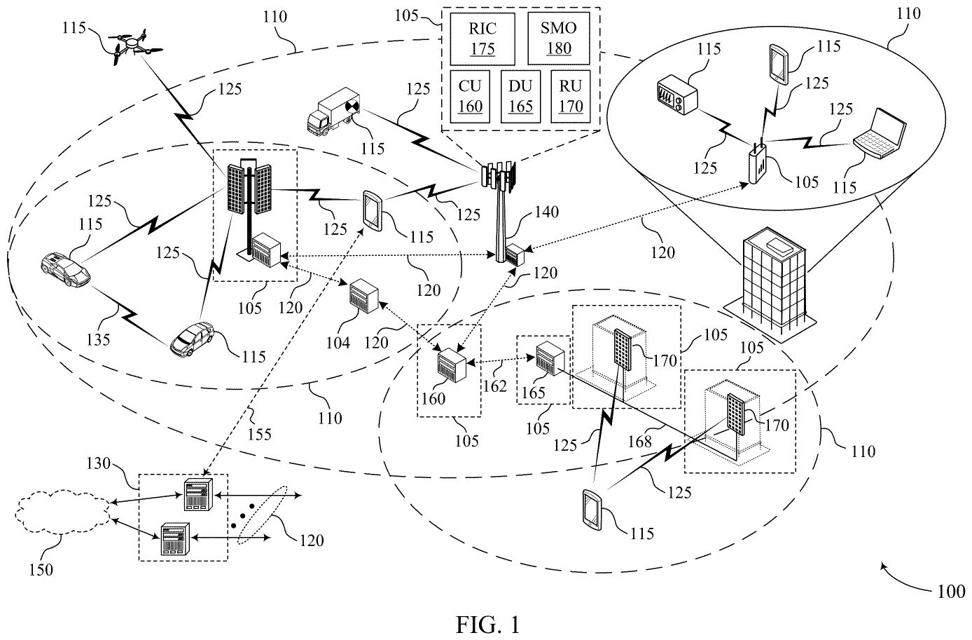

FIG. 1 shows an example of a wireless communications system 100 that supports WUS range extension in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support WUS range extension as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the network entities 105 or the UEs 115 may be

expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with various aspects discussed herein, one or more UEs 115 may operate in accordance with a low power state in which an LP-WUR (e.g., a secondary transceiver of a UE 115) may monitor for a WUS during a low-power state of the UE 115, and may transition the UE 115 to a higher power state after detection of the WUS (e.g., transition a primary transceiver of the UE 115 to a wake state from a sleep state). The LP-WUR of a UE 115 may be switched on and off quickly, and may be capable of receiving and processing some simple signals. For example, the LP-WUR may be associated with a limited bandwidth and/or simpler waveforms such as OOK. Accordingly, an LP-WUR may use less power than a primary radio or primary transceiver of a UE 115. In some examples, an LP-WUR of a UE 115 may be capable of transmitting in addition to receiving. For example, the LP-WUR of a UE 115 may be capable of transmitting limited bandwidth and/or simple signals (e.g., OOK modulated signals).

A network entity 105 may transmit a WUS to a UE 115 when the network entity 105 has data to communicate with the UE 115. For example, after activating the primary transceiver, the UE 115 may monitor for a PDCCH transmission that may schedule additional communications with the network entity 105. WUSs may include identifiers for the UEs 115 to indicate the intended UE 115, and such an identifier may be configured for a UE 115 while the primary transceiver of the UE 115 is in the awake or active mode.

For example, for the RRC idle and inactive modes, a UE 115 may monitor for LP-WUS for an indication from the network entity 105 to wake up and monitor paging occasions for paging messages. In some examples, for the RRC connected mode, PDCCH monitoring may be triggered by an LP-WUS with a connected mode discontinuous reception configuration (C-DRX). In some examples, the UE 115 may perform LP-WUS monitoring in the RRC connected mode according to the LP-WUS monitoring configuration before drx-onDurationTimer to trigger the starting of the drx-onDurationTimer (e.g., which may replace DCP, a downlink control information (DCI) with cyclic redundancy check (CRC) scrambled by power saving radio network temporary identifier (PS-RNTI)). In some examples, the UE 115 may perform LP-WUS monitoring in the RRC connected mode outside C-DRX active time according to the LP-WUS monitoring configuration to trigger PDCCH monitoring (e.g., where PDCCH monitoring may be irrespective of drx-onDurationTimer). In some examples, the UE 115 may perform LP-WUS monitoring in the RRC connected mode inside C-DRX active time according to the LP-WUS monitoring configuration to trigger PDCCH monitoring.

As WUSs may use OOK waveforms (e.g., may be modulated using OOK), WUSs may have a shorter range than OFDM waveforms. Accordingly, in some aspects, a first UE 115 may be configured to relay a WUS for a second UE 115. For example, the first UE 115 may be within the WUS range of the network entity 105 while the second UE 115 may be outside of the WUS range of the network entity. In some examples, the network entity 105 may determine whether a particular UE 115 is within the WUS range of the network entity based on channel conditions indicated in CSI reports from the UEs 115. The network entity 105 may indicate to the first UE 115 to relay WUSs that include the identifier for the second UE 115. Accordingly, the second UE 115 may save energy via transitioning the primary transceiver to the sleep mode even when the second UE 115 is outside the WUS range of the network entity 105. In some examples, the first UE 115 may receive and relay the WUS intended for the second UE via a secondary transceiver (e.g., the LP-WUR) of the first UE 115. Accordingly, the first UE 115 may relay WUSs while in a reduced power mode (e.g., a sleep mode). The network entity 105 may configure WUS monitoring occasions for the UEs. For example, the network entity 105 may configure, for the first UE 115, WUS monitoring occasions and WUS relaying occasions. The network entity 105 may configure WUS monitoring occasions for the second UE 115 that correspond to the WUS relaying occasions. The first UE 115 may determine whether to relay a particular WUS based on the UE identifier indicated in the WUS (e.g., whether the UE identifier indicates the WUS is intended for the first UE 115 or the second UE 115.

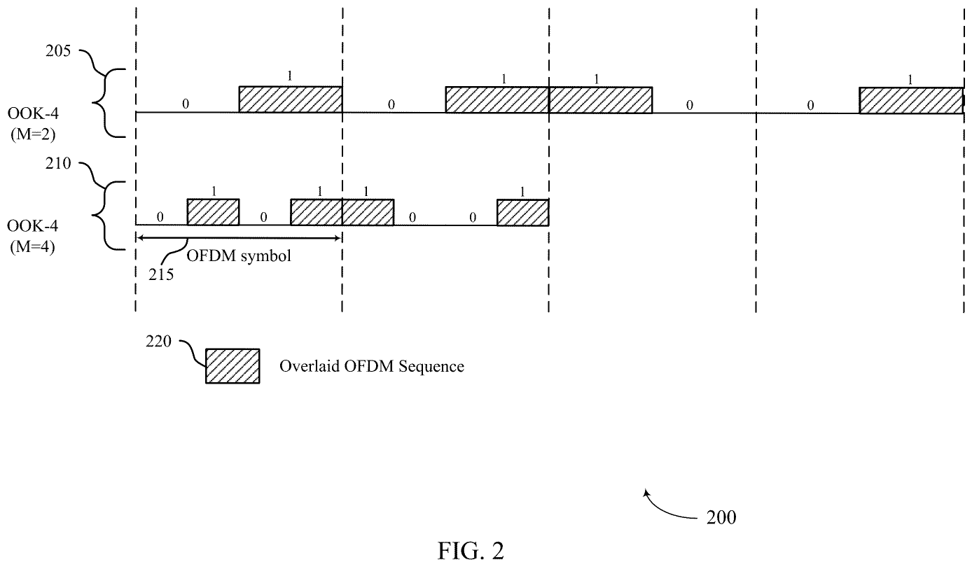

FIG. 2 shows an example of a timing diagram 200 that supports WUS range extension in accordance with one or more aspects of the present disclosure. The timing diagram 200 may implement or be implemented by one or more aspects of the wireless communications system 100. For example, the timing diagram 200 may be implemented by a network entity 105 and a UE 115 as described herein.

As shown in the timing diagram 200, an OOK waveform may be a sequence of high power/amplitude durations and low (or zero) power/amplitude (or off) durations. For example, the timing diagram 200 illustrates a first OOK signal 205, that is a OOK-4 signal with M=2 (e.g., there are two chips per OFDM symbol 215 duration). In this example, the first OOK signal 205 may transmit the bit sequence ‘01011001’ over four OFDM symbols 215. The timing diagram 200 also illustrates a second OOK signal 210, that is a OOK-4 signal with M=4 (e.g., there are four chips per OFDM symbol 215 duration). In this example, the second OOK signal 210 may transmit the bit sequence ‘01011001’ over two OFDM symbols 215. In the timing diagram 200, the ‘ON’ portions of the OFDM symbols 215 may include an overlaid OFDM sequence 220, which in some implementations may also be used to convey control information via the LP-WUS. In some examples, the overlaid OFDM sequence may be a Gold sequence, an M sequence, a computer searched sequence, or a Zadoff-Chu sequence.

In some aspects, the first OOK signal 205 and/or the second OOK signal 210 may carry wakeup information and control information via overlaid OFDM sequence 220. The control information may include, for example, a paging PDCCH or paging early indication (PEI) for idle and inactive modes. In some examples, an LP-WUS may use 11 physical resource blocks (PRBs) with a subcarrier spacing (SCS) of 30 kHz.

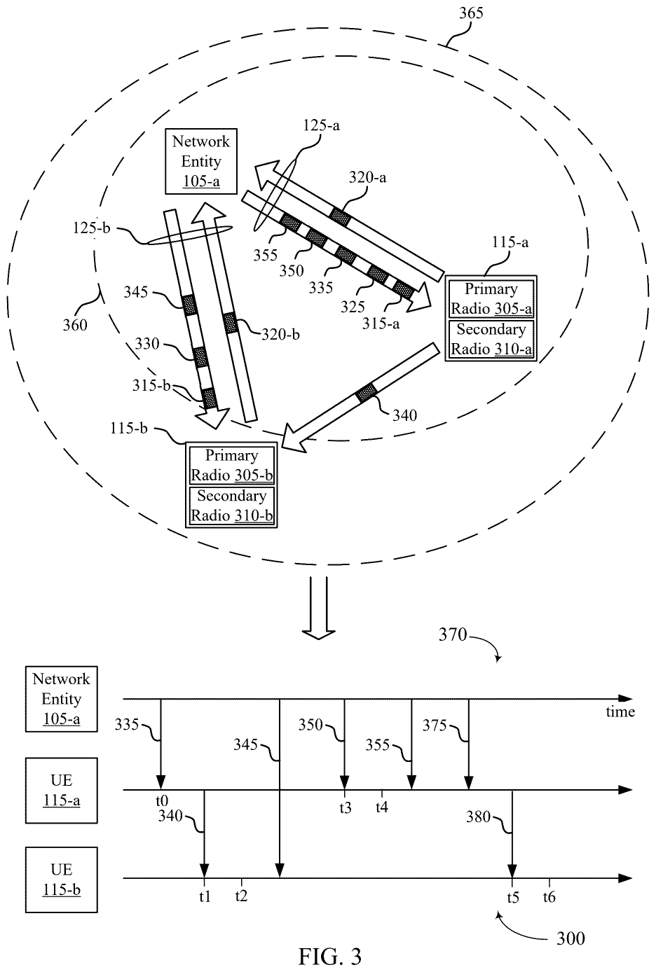

FIG. 3 shows an example of a wireless communications system 300 that supports WUS range extension in accordance with one or more aspects of the present disclosure. The wireless communications system 300 may implement aspects of or may be implemented by aspects of the wireless communications system 100 or the timing diagram 200. For example, the wireless communications system 300 includes a UE 115-a and a UE 115-b, which may be examples of a UE 115 as described herein. The wireless communications system 300 also includes a network entity 105-a, which may be an example of a network entity 105 as described herein.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-b. The communication link 125-a and the communication link 125-b may include bi-directional links that enable both uplink and downlink communications. For example, the UE 115-a may transmit uplink signals, such as uplink control signals or uplink data signals, to the network entity 105-a using the communication link 125-a and the network entity 105-a may transmit downlink signals, such as downlink control signals or downlink data signals, to the UE 115-a using the communication link 125-a. The UE 115-b may transmit uplink signals, such as uplink control signals or uplink data signals, to the network entity 105-a using the communication link 125-b and the network entity 105-a may transmit downlink signals, such as downlink control signals or downlink data signals, to the UE 115-b using the communication link 125-b.

The UE 115-a may include a primary radio 305-a (e.g., a main radio or primary transceiver as described herein) and a secondary radio 310-a (e.g., an LP-WUR or a secondary transceiver as described herein). The UE 115-b may include a primary radio 305-b (e.g., a main radio or primary transceiver as described herein) and a secondary radio 310-b (e.g., an LP-WUR or a secondary transceiver as described herein). To save energy, the UEs 115 may enter a low power state in which the primary radios 305 are in a sleep state and the UEs 115 may monitor for WUSs using the secondary radios 310. As described herein, WUSs may be modulated using OOK modulation and may have a smaller range than other signals (e.g., OFDM modulated signals) such as PDCCH transmissions.

As shown, the UE 115-a may be within a first range 360 (e.g., coverage area) of the network entity 105-a, and the UE 115-b may be outside of the first range 360 but within a second range 365. For example, the first range 360 may correspond to the WUS range for the network entity 105-a and the second range 365 may correspond to the PDCCH range of the network entity 105-a. In some examples, the first range 360 (e.g., the WUS range) may be the same as the range of a Msg3 (e.g., an uplink signal) in a 4-step random access channel (RACH) procedure. In some examples, the network entity 105-a may identify or determine whether a particular UE 115 is within the first range 360 (e.g., the WUS range) based on a CSI report 320 received by the network entity 105-a from the UE 115. For example, the network entity 105-a may transmit a set of CSI-RSs 315-a to the UE 115-a. The UE 115-a may receive and perform measurements on the set of CSI-RS 315-a. The UE 115-a may transmit a CSI report 320-a to the network entity 105-a based on the measurements of the set of CSI-RSs 315-a. Based on the channel conditions indicated in the CSI report 320-a, the network entity 105-a may identify or determine that the UE 115-a is within the first range 360. Similarly, the network entity 105-a may transmit a set of CSI-RSs 315-b to the UE 115-b. The UE 115-b may receive and perform measurements on the set of CSI-RS 315-b. The UE 115-b may transmit a CSI report 320-b to the network entity 105-a based on the measurements of the set of CSI-RSs 315-b. Based on the channel conditions indicated in the CSI report 320-b, the network entity 105-a may identify or determine that the UE 115-b is outside of the first range 360 and is within the second range 365.

As described herein, UEs 115 may save energy by entering the primary radios 305 into a sleep mode and monitoring for WUSs via secondary radios 310. For example, the network entity 105-a may transmit control signaling 325 to the UE 115-a that indicates for the UE 115-a to enter the low power mode and to monitor for WUSs. In some examples, the UE 115-a may request to enter a low power mode (e.g., may transmit a request via the communication link 125-a), and the control signaling 325 may be responsive to the request. The UE 115-b, however, may be outside of the first range 360 of a WUS for the network entity 105. In some examples, as described herein, the UE 115-a may be configured to relay WUSs for the UE 115-b to enable the UE 115-b to enter the low power mode and to monitor for WUSs when the UE 115-b is outside of the WUS range of the network entity 105-a (e.g., but within a proximity of the UE 115-a sufficient to receive a WUS relayed from the UE 115-a).

For example, the control signaling 325 may indicate for the UE 115-a to relay WUSs that include a UE identifier associated with the UE 115-b. In some examples, the control signaling 325 may indicate a UE identifier associated with the UE 115-a and/or the UE 115-b. In some examples, the control signaling 325 may indicate a set of WUS monitoring occasions for the UE 115-a and/or a set of WUS relaying occasions for relaying WUSs that include a UE identifier associated with the UE 115-b. The network entity 105-a may transmit control signaling 330 to the UE 115-b that indicates the UE identifier associated with the UE 115-b and/or that configures or schedules a set of WUS monitoring occasions for the UE 115-b. The WUS monitoring occasions for the UE 115-b may correspond to the WUS relaying occasions for relaying WUSs that include a UE identifier associated with the UE 115-b. The control signaling 325 may include multiple control messages (e.g., multiple RRC messages, MAC control elements (MAC-CEs), and/or multiple DCI messages). Similarly, the control signaling 330 may include multiple control messages. The UE 115-a may receive the control signaling 325 via the primary radio 305-a (e.g., while the primary radio 305-a is in a wake state and the UE 115-a is not in a low power state). Similarly, the UE 115-b may receive the control signaling 330 via the primary radio 305-a (e.g., while the primary radio 305-b is in a wake state and the UE 115-b is not in a low power state).

While the primary radio 305-b of the UE 115-b is in a sleep state, at time t0 the network entity 105-a may transmit a WUS 335 that includes the identifier associated with the UE 115-b. The network entity 105-a may transmit the WUS 335 in a WUS monitoring occasion configured for the UE 115-a. As shown in the timing diagram 370, at time t1, the UE 115-a may transmit a relay 340 of the WUS 335. In some examples, the UE 115-a may receive the WUS 335 and may transmit the relay 340 of the WUS 335 using the secondary radio 310-a. For example, the UE 115-a may relay WUSs while in a low power state. In some examples, the UE 115-a may receive the WUS 335 and may transmit the relay 340 of the WUS 335 using the primary radio 305-a. The UE 115-b may receive the relay 340 of the WUS 335 using the secondary radio 310-b and may initiate wake up of the primary radio 305-b of the UE 115-b. The primary radio 305-b may be in the awake state and ready to communicate at time t2. The duration between t1 and t2 may correspond to a ramp up time for the primary radio 305-b. After time t2, the network entity 105-a may transmit a PDCCH transmission 345 to the UE 115-b, which the UE 115-b may receive via the primary radio 305-b.

While the primary radio 305-a of the UE 115-a is in a sleep state, at time t3 the network entity 105-a may transmit a WUS 350 that includes the identifier associated with the UE 115-a. The network entity 105-a may transmit the WUS 350 in a WUS monitoring occasion configured for the UE 115-a. The UE 115-a may receive the WUS 350 using the secondary radio 310-a and may initiate wake up of the primary radio 305-a of the UE 115-a. The primary radio 305-a may be in the awake state and ready to communicate at time t4. The duration between t3 and t4 may correspond to a ramp up time for the primary radio 305-a. After time t4, the network entity 105-a may transmit a PDCCH transmission 355 to the UE 115-a, which the UE 115-a may receive via the primary radio 305-a.

If the UE 115-a does not include a secondary radio 310-a capable of transmitting, the UE 115-a may relay WUSs via the primary radio 305-a. In such an example, the network entity 105-a may wake the primary radio 305-a of the UE 115-a (e.g., via the WUS 350) in order for the UE 115-a to relay a WUS 375 to the UE 115-b. For example, the PDCCH transmission 355 may indicate for the UE 115-a to relay WUSs that include an identifier associated with the UE 115-b. The UE 115-a may receive the WUS 375. At time t5, the UE 115-a may transmit a relay 380 of the WUS 375 using the primary radio 305-a of the UE 115-a. The UE 115-b may receive the relay 380 of the WUS 375 using the secondary radio 310-b and may initiate wake up of the primary radio 305-b of the UE 115-b. The primary radio 305-b may be in the awake state and ready to communicate at time t6. The duration between t5 and t6 may correspond to a ramp up time for the primary radio 305-b. Accordingly, if the UE 115-a does not include a secondary radio 310-a capable of transmitting, the duration for the network entity 105-a to wake the primary radio 305-b UE 115-b may be the duration between t3 and t6, which may be larger than the duration between t0 and t2 to wake the primary radio 305-b UE 115-b if the UE 115-a includes a secondary radio 310-a capable of transmitting.

As described herein, the UE 115-a may be configured with a set of WUS monitoring occasions targeted for the UE 115-b and a set of WUS transmission occasions (e.g., a set of WUS relaying occasions for relaying WUSs that include a UE identifier associated with the UE 115-b). If the UE 115-a receives a WUS targeted for the UE 115-b (e.g., including the identifier associated with the UE 115-b such as the WUS 335 or the WUS 375) in a configured WUS monitoring occasion, the UE 115-a may transmit the received WUS (e.g., may transmit the relay 340 of the WUS 335 or the relay 380 of the WUS 375) in a corresponding WUS transmission occasion. In some examples, there may be a mapping between each of the WUS monitoring occasions and one or more of the WUS transmission occasions for the UE 115-a. For example, the control signaling 325 may indicate the mapping. For example, if the UE 115-a receives the WUS 335 in a WUS monitoring occasion indexed 1, the UE 115-a may transmit the relay 340 of the WUS 335 in WUS transmission occasions indexed 1a and/or 1b. In some examples, the UE 115-a may be configured with a single set of WUS monitoring occasions in which the UE 115-a may receive WUSs targeted for the UE 115-b (e.g., including the identifier associated with the UE 115-b) or the UE 115-a (e.g., including the identifier associated with the UE 115-a). For example, the time/frequency resources configured for the WUS monitoring occasions for the UE 115-a to receive WUSs targeted for the UE 115-a and the time/frequency resources configured for the WUS monitoring occasions for the UE 115-a to receive WUSs targeted for the UE 115-b may be identical.

The network entity 105-a may transmit WUSs targeted for the UE 115-b in either or both of the WUS monitoring occasions configured for the UE 115-a (e.g., for the UE 115-a to relay onto the UE 115-b) or the WUS monitoring occasions configured for the UE 115-b (e.g., for direct transmission to the UE 115-b).

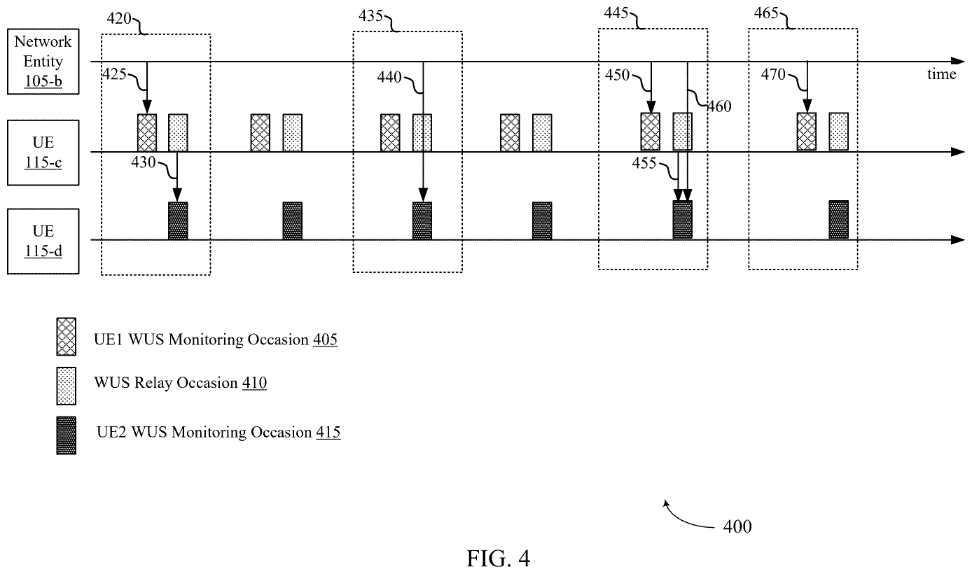

FIG. 4 shows an example of a signaling diagram 400 that supports WUS range extension in accordance with one or more aspects of the present disclosure. The signaling diagram 400 may implement aspects of or may be implemented by aspects of the wireless communications system 100, the timing diagram 200, or the wireless communications system 300. For example, the signaling diagram 400 includes a UE 115-c and a UE 115-d, which may be examples of a UE 115 as described herein. The signaling diagram 400 also includes a network entity 105-b, which may be an example of a network entity 105 as described herein.

As described herein, a UE 115-c may be configured to relay WUSs that target the UE 115-d (e.g., include an identifier for the UE 115-d). For example, the UE 115-c may be configured with WUS monitoring occasions 405 and WUS transmission occasions 410 (e.g., a set of WUS relaying occasions for relaying WUSs that include a UE identifier associated with the UE 115-d). The UE 115-d may be configured with WUS monitoring occasions 415 that correspond to the WUS transmission occasions 410 (e.g., are in the same time/frequency resources).

In some examples, as shown in the scenario 420, the network entity 105-b may transmit a WUS 425 that targets the UE 115-d in a WUS monitoring occasion 405. The UE 115-c may identify that the WUS 425 targets the UE 115-d (e.g., based on inclusion of the identifier associated with the UE 115-d in the WUS 425), and the UE 115-c may transmit a relay 430 of the WUS 425 in the WUS transmission occasion 410. The UE 115-d may receive the relay 430 of the WUS 425 in the WUS monitoring occasion 415 that corresponds to WUS transmission occasion 410. Based on reception of the WUS 425 (e.g., the relay 430 of the WUS 425), the UE 115-d may initiate waking up the primary radio of the UE 115-d.

In some examples, as shown in the scenario 435, the network entity 105-b may transmit a WUS 440 that targets the UE 115-d in a WUS monitoring occasion 415. The UE 115-c may not receive the WUS 440 as the WUS is transmitted in the WUS monitoring occasion 415 and not a WUS monitoring occasion 405. Accordingly, the UE 115-c may not relay the WUS 440. The UE 115-d may receive the WUS 440 and may initiate waking up the primary radio of the UE 115-d based on reception of the WUS 440.

In some examples, as shown in the scenario 445, the network entity 105-b may transmit a WUS 450 that targets the UE 115-d in a WUS monitoring occasion 405. The UE 115-c may identify that the WUS 450 targets the UE 115-d (e.g., based on inclusion of the identifier associated with the UE 115-d in the WUS 450), and the UE 115-c may transmit a relay 455 of the WUS 450 in the WUS transmission occasion 410. The network entity 105-b may also transmit a WUS 460 that targets the UE 115-d in the same WUS monitoring occasion 415 that corresponds to the WUS transmission occasion 410 that the UE 115-c transmits the relay 455 of the WUS 450. The UE 115-d may receive the relay 455 of the WUS 450 and/or the WUS 460 in the WUS monitoring occasion 415. Based on reception of the WUS 450 (e.g., the relay 455 of the WUS 450) and/or the WUS 460, the UE 115-d may initiate waking up the primary radio of the UE 115-d.

In some examples, as shown in the scenario 465, the network entity 105-b may transmit a WUS 470 that targets the UE 115-c (e.g., that includes the identifier associated with the UE 115-c) in a WUS monitoring occasion 415. The UE 115-c may receive the WUS 470 and may initiate waking up the primary radio of the UE 115-c based on reception of the WUS 470. As the WUS 470 targets the UE 115-c, the UE 115-c may not relay the WUS 470.

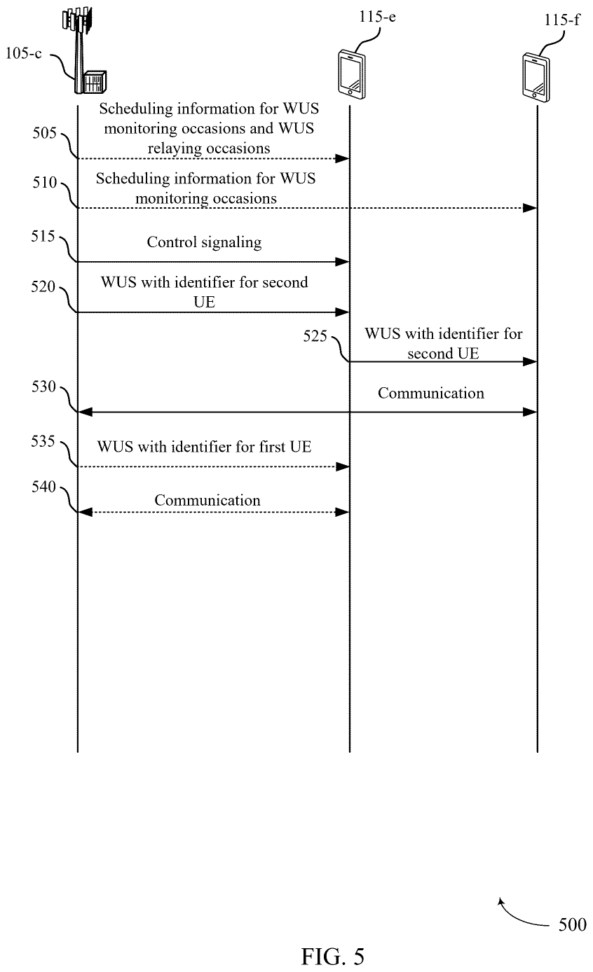

FIG. 5 shows an example of a process flow 500 that supports WUS range extension in accordance with one or more aspects of the present disclosure. The process flow 500 may implement aspects of or may be implemented by aspects of the wireless communications system 100, the timing diagram 200, the wireless communications system 300, or the signaling diagram 400. For example, the process flow 500 includes a first UE 115-e and a second UE 115-f, which may be examples of a UE 115 as described herein. The process flow 500 also includes a network entity 105-c, which may be an example of a network entity 105 as described herein.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

In some examples, at 505, the network entity 105-c may transmit, to the first UE 115-e, first scheduling information for a first set of WUS monitoring occasions (e.g., the WUS monitoring occasions 405 as described with reference to FIG. 4) and a set of WUS relay occasions (e.g., the WUS transmission occasions 410 as described with reference to FIG. 4). In some examples, the first scheduling information indicates a mapping between the set of WUS monitoring occasions and the set of WUS relay occasions. In some examples, at 510, the network entity may transmit, to the second UE 115-f, second scheduling information for a second set of WUS monitoring occasions (e.g., the WUS monitoring occasions 415 as described with reference to FIG. 4) that correspond to the set of WUS relay occasions.

At 515, the network entity 105-c may transmit, and the first UE 115-e may receive, control signaling that indicates for the first UE 115-e to relay one or more WUSs that each include an identifier associated with the second UE 115-f.

At 520, the network entity 105-c may transmit, and the first UE 115-e may receive, a WUS that includes the identifier associated with the second UE 115-f. The WUS may be modulated in accordance with an OOK modulation scheme. For example, the OOK modulation scheme may be one of OOK type one or OOK type four.

At 525, the first UE 115-e may relay, and the second UE 115-f may receive, the WUS based on the control signaling at 515 and based on the WUS including the identifier associated with the second UE 115-f.

In some examples, the first UE 115-e may receive the WUS and may relay the WUS via a secondary transceiver (e.g., a secondary radio 310-a) of the first UE 115-e while a primary transceiver (e.g., a primary radio 305-a) of the first UE 115-e is in a sleep mode.

At 530, the second UE 115-f may perform a communication with the network entity based on reception of the WUS at 525. For example, the communication at 530 may be reception of a PDCCH transmission.

In some examples, the second UE 115-f may receive the WUS at 525 via a secondary transceiver (e.g., a secondary radio 310-b) of the second UE 115-f while a primary transceiver (e.g., a primary radio 305-b) of the second UE 115-f is in a sleep mode. In some such examples, the second UE 115-f may transition the primary transceiver to an active mode based on the reception of the WUS at 525, and the communication at 530 may be performed via the primary transceiver of the second UE 115-f.

In some examples, the first UE 115-e may receive the WUS at 520 via a first WUS monitoring occasion of the set of WUS monitoring occasions configured at 505 and the first UE 115-e may relay the WUS at 525 via a WUS relay occasion of the set of WUS relay occasions. The second UE 115-f may receive the relayed WUS via a WUS monitoring occasion of the second set of WUS monitoring occasions configured at 510 that corresponds to the WUS relay occasion.

In some examples, at 535, the first UE 115-e may receive, via a second WUS monitoring occasion of the set of WUS monitoring occasions configured at 505, a second WUS that includes a second identifier associated with the first UE 115-e. The WUS may be modulated in accordance with the OOK modulation scheme. In some such examples, at 540, the first UE 115-e may perform a communication with the network entity based on reception of the second WUS at 535. For example, the communication at 540 may be reception of a PDCCH transmission. In some examples, the first UE 115-e may receive the WUS at 535 via a secondary transceiver (e.g., a secondary radio 310-a) of the first UE 115-e while a primary transceiver (e.g., a primary radio 305-a) of the first UE 115-e is in a sleep mode. In some such examples, the first UE 115-e may transition the primary transceiver to an active mode based on the reception of the WUS at 535, and the communication at 540 may be performed via the primary transceiver of the first UE 115-e. In some examples, the first UE 115-e may receive, prior to the reception of the second WUS at 535, an indication of the second identifier associated with the first UE 115-e.

In some examples, the network entity 105-c may transmit a first set of CSI-RSs for the first UE 115-e. In some such examples, the network entity 105-c may receive a first CSI report associated with the first UE 115-e based on the first set of CSI-RSs. In some such examples, the network entity 105-c may transmit a second set of CSI-RSs for the second UE 115-f. In some such examples, the network entity 105-c may receive a second CSI report associated with the second UE 115-f based on the second set of CSI-RSs. Transmission of the control signaling at 515 may be based on the first CSI report and the second CSI report. For example, based on the first CSI report, the network entity 105-c may identify or determine that the first UE 115-e is within a WUS range of the network entity 105-c, and based on the second CSI report, the network entity 105-c may identify or determine that the second UE 115-f is not within a WUS range of the network entity 105-c. Based on the first and second CSI reports, the network entity 105-c may identify or determine that the first UE 115-e may relay WUSs to the second UE 115-f.

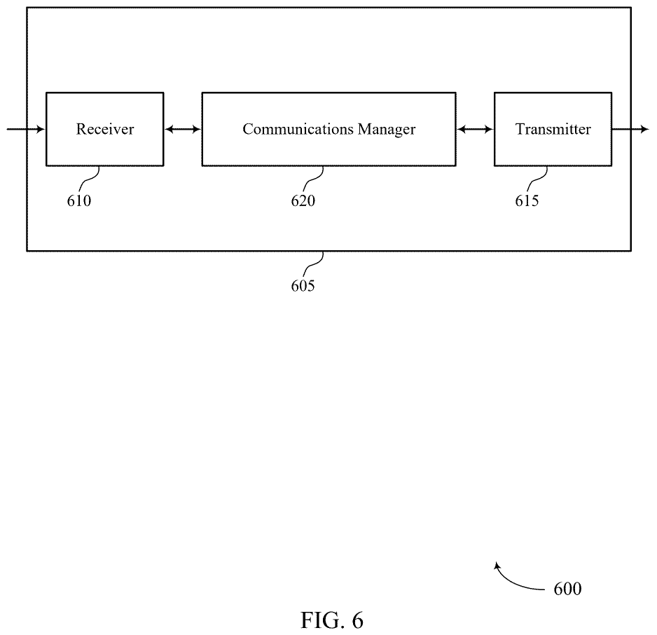

FIG. 6 shows a block diagram 600 of a device 605 that supports WUS range extension in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to WUS range extension). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to WUS range extension). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of WUS range extension as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, at the first UE, control signaling that indicates for the first UE to relay one or more WUSs that each include an identifier associated with a second UE. The communications manager 620 is capable of, configured to, or operable to support a means for receiving, at the first UE, a WUS that includes the identifier associated with the second UE, where the WUS is modulated in accordance with an OOK modulation scheme. The communications manager 620 is capable of, configured to, or operable to support a means for relaying, by the first UE, the WUS to the second UE based on the control signaling and based on the WUS including the identifier associated with the second UE.

Additionally, or alternatively, the communications manager 620 may support wireless communications in accordance with examples as disclosed herein. For example, the communications manager 620 is capable of, configured to, or operable to support a means for receiving, from a first UE, a WUS that includes an identifier associated with the second UE and that is a relayed signal from a network entity, where the WUS is modulated in accordance with an OOK modulation scheme. The communications manager 620 is capable of, configured to, or operable to support a means for performing a communication with the network entity based on reception of the WUS.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources.

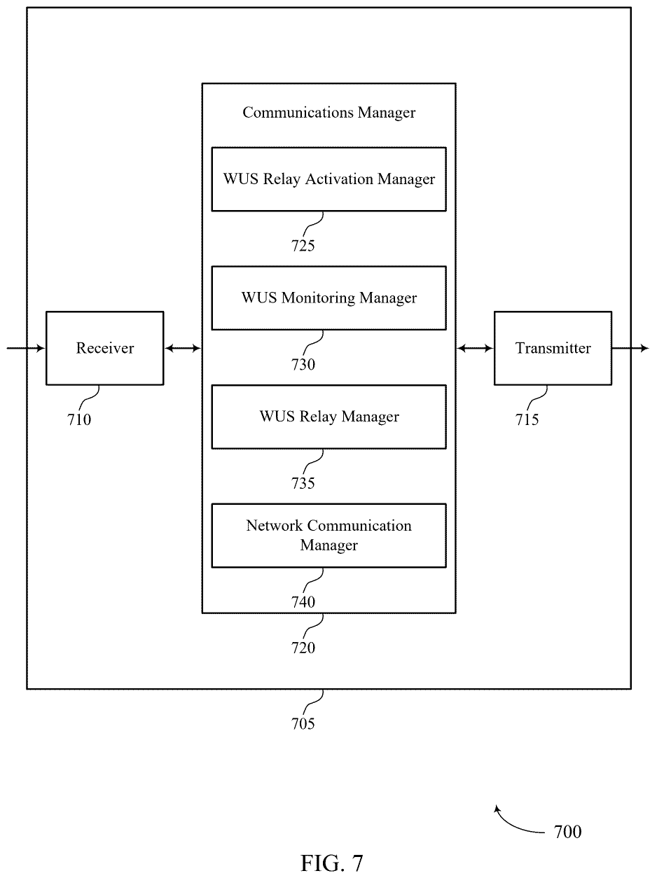

FIG. 7 shows a block diagram 700 of a device 705 that supports WUS range extension in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to WUS range extension). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to WUS range extension). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of WUS range extension as described herein. For example, the communications manager 720 may include a WUS relay activation manager 725, a WUS monitoring manager 730, a WUS relay manager 735, a network communication manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The WUS relay activation manager 725 is capable of, configured to, or operable to support a means for receiving, at the first UE, control signaling that indicates for the first UE to relay one or more WUSs that each include an identifier associated with a second UE. The WUS monitoring manager 730 is capable of, configured to, or operable to support a means for receiving, at the first UE, a WUS that includes the identifier associated with the second UE, where the WUS is modulated in accordance with an OOK modulation scheme. The WUS relay manager 735 is capable of, configured to, or operable to support a means for relaying, by the first UE, the WUS to the second UE based on the control signaling and based on the WUS including the identifier associated with the second UE.

Additionally, or alternatively, the communications manager 720 may support wireless communications in accordance with examples as disclosed herein. The WUS monitoring manager 730 is capable of, configured to, or operable to support a means for receiving, from a first UE, a WUS that includes an identifier associated with the second UE and that is a relayed signal from a network entity, where the WUS is modulated in accordance with an OOK modulation scheme. The network communication manager 740 is capable of, configured to, or operable to support a means for performing a communication with the network entity based on reception of the WUS.

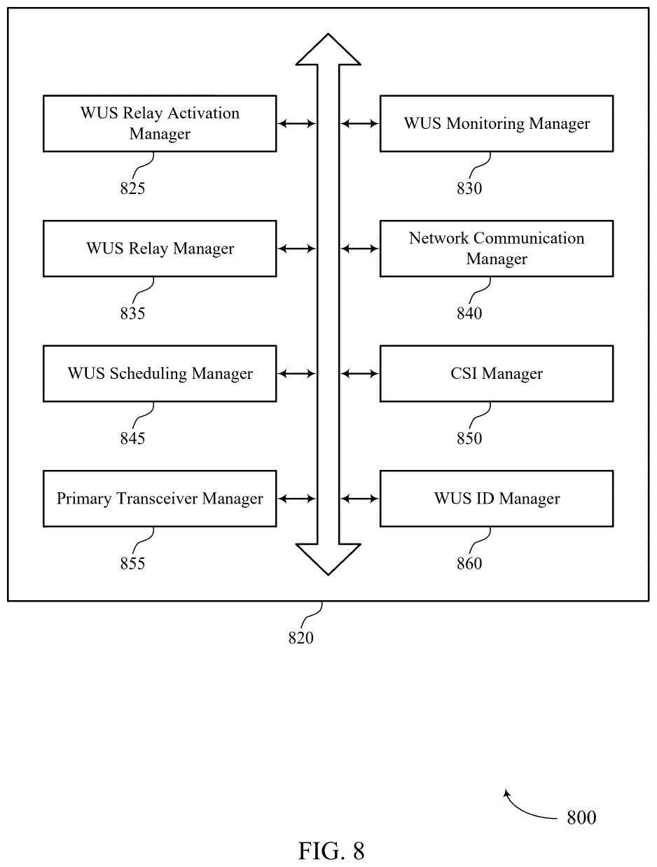

FIG. 8 shows a block diagram 800 of a communications manager 820 that supports WUS range extension in accordance with one or more aspects of the present disclosure. The communications manager 820 may be an example of aspects of a communications manager 620, a communications manager 720, or both, as described herein. The communications manager 820, or various components thereof, may be an example of means for performing various aspects of WUS range extension as described herein. For example, the communications manager 820 may include a WUS relay activation manager 825, a WUS monitoring manager 830, a WUS relay manager 835, a network communication manager 840, a WUS scheduling manager 845, a CSI manager 850, a primary transceiver manager 855, a WUS ID manager 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The WUS relay activation manager 825 is capable of, configured to, or operable to support a means for receiving, at the first UE, control signaling that indicates for the first UE to relay one or more WUSs that each include an identifier associated with a second UE. The WUS monitoring manager 830 is capable of, configured to, or operable to support a means for receiving, at the first UE, a WUS that includes the identifier associated with the second UE, where the WUS is modulated in accordance with an OOK modulation scheme. The WUS relay manager 835 is capable of, configured to, or operable to support a means for relaying, by the first UE, the WUS to the second UE based on the control signaling and based on the WUS including the identifier associated with the second UE.

In some examples, the first UE receives the WUS and relays the WUS via a secondary transceiver of the first UE while a primary transceiver of the first UE is in a sleep mode.

In some examples, the WUS scheduling manager 845 is capable of, configured to, or operable to support a means for receiving, from a network entity, scheduling information for a set of WUS monitoring occasions and a set of WUS relay occasions, where the WUS is received via a WUS monitoring occasion of the set of WUS monitoring occasions, and where the WUS is relayed via a WUS relay occasion of the set of WUS relay occasions.

In some examples, the WUS monitoring manager 830 is capable of, configured to, or operable to support a means for receiving, via a second WUS monitoring occasion of the set of WUS monitoring occasions, a second WUS that includes a second identifier associated with the first UE, where the second WUS is modulated in accordance with the OOK modulation scheme. In some examples, the network communication manager 840 is capable of, configured to, or operable to support a means for performing a communication with the network entity based on reception of the second WUS.

In some examples, the WUS ID manager 860 is capable of, configured to, or operable to support a means for receiving, prior to the reception of the second WUS, an indication of the second identifier associated with the first UE.

In some examples, the first UE receives the second WUS via a secondary transceiver of the second UE while a primary transceiver of the first UE is in a sleep mode, and the primary transceiver manager 855 is capable of, configured to, or operable to support a means for transitioning the primary transceiver to an active mode based on the reception of the WUS, where the communication is performed via the primary transceiver.

In some examples, the scheduling information indicates a mapping between the set of WUS monitoring occasions and the set of WUS relay occasions.

In some examples, the OOK modulation scheme is one of OOK type one or OOK type four.

In some examples, the CSI manager 850 is capable of, configured to, or operable to support a means for receiving a set of CSI-RSs. In some examples, the CSI manager 850 is capable of, configured to, or operable to support a means for transmitting a CSI report based on one or more measurements of the set of CSI-RSs, where reception of the control signaling is based on the CSI report.

Additionally, or alternatively, the communications manager 820 may support wireless communications in accordance with examples as disclosed herein. In some examples, the WUS monitoring manager 830 is capable of, configured to, or operable to support a means for receiving, from a first UE, a WUS that includes an identifier associated with the second UE and that is a relayed signal from a network entity, where the WUS is modulated in accordance with an OOK modulation scheme. The network communication manager 840 is capable of, configured to, or operable to support a means for performing a communication with the network entity based on reception of the WUS.

In some examples, the second UE receives the WUS via a secondary transceiver of the second UE while a primary transceiver of the second UE is in a sleep mode, and the primary transceiver manager 855 is capable of, configured to, or operable to support a means for transitioning the primary transceiver to an active mode based on the reception of the WUS, where the communication is performed via the primary transceiver.

In some examples, the WUS ID manager 860 is capable of, configured to, or operable to support a means for receiving, from the network entity prior to the reception of the WUS, an indication of the identifier for the second UE.

In some examples, to support performing the communication with the network entity, the network communication manager 840 is capable of, configured to, or operable to support a means for receiving a physical downlink control channel communication.

In some examples, the WUS scheduling manager 845 is capable of, configured to, or operable to support a means for receiving, from the network entity, scheduling information for a set of WUS monitoring occasions, where the WUS is received via a WUS monitoring occasion of the set of WUS monitoring occasions.

In some examples, the CSI manager 850 is capable of, configured to, or operable to support a means for receiving a set of CSI-RSs. In some examples, the CSI manager 850 is capable of, configured to, or operable to support a means for transmitting a CSI report based on one or more measurements of the set of CSI-RSs, where the reception of the WUS from the first UE is based on the CSI report.

In some examples, the OOK modulation scheme is one of OOK type one or OOK type four.

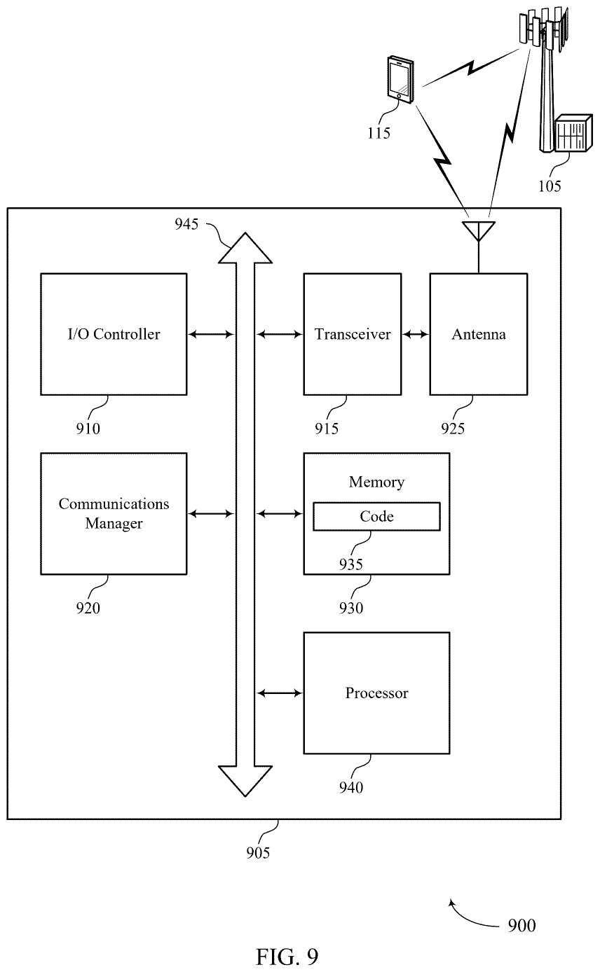

FIG. 9 shows a diagram of a system 900 including a device 905 that supports WUS range extension in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting WUS range extension). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, at the first UE, control signaling that indicates for the first UE to relay one or more WUSs that each include an identifier associated with a second UE. The communications manager 920 is capable of, configured to, or operable to support a means for receiving, at the first UE, a WUS that includes the identifier associated with the second UE, where the WUS is modulated in accordance with an OOK modulation scheme. The communications manager 920 is capable of, configured to, or operable to support a means for relaying, by the first UE, the WUS to the second UE based on the control signaling and based on the WUS including the identifier associated with the second UE.

Additionally, or alternatively, the communications manager 920 may support wireless communications in accordance with examples as disclosed herein. For example, the communications manager 920 is capable of, configured to, or operable to support a means for receiving, from a first UE, a WUS that includes an identifier associated with the second UE and that is a relayed signal from a network entity, where the WUS is modulated in accordance with an OOK modulation scheme. The communications manager 920 is capable of, configured to, or operable to support a means for performing a communication with the network entity based on reception of the WUS.

By including or configuring the communications manager 920 in accordance with examples as described herein, the device 905 may support techniques for reduced latency, reduced power consumption, more efficient utilization of communication resources, improved coordination between devices, and longer battery life.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of WUS range extension as described herein, or the at least one processor 940 and the at least one memory 930 may be otherwise configured to, individually or collectively, perform or support such operations.

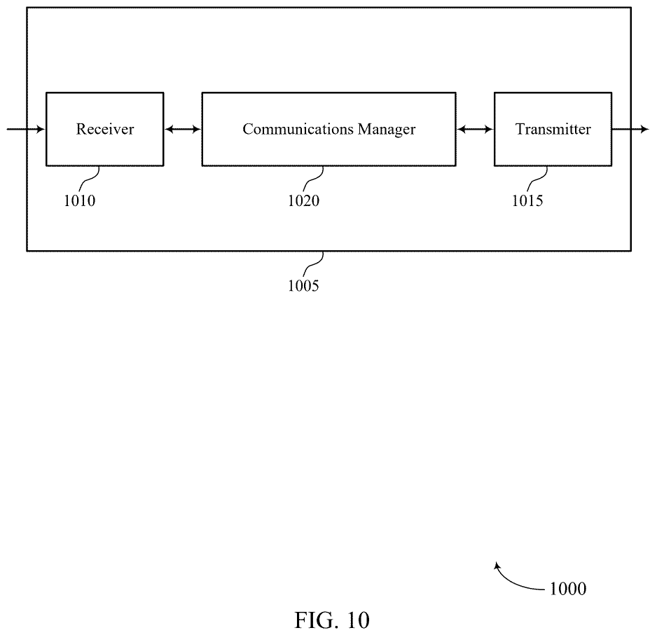

FIG. 10 shows a block diagram 1000 of a device 1005 that supports WUS range extension in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of WUS range extension as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, for a first UE, control signaling that indicates for the first UE to relay one or more WUSs that each include an identifier associated with a second UE. The communications manager 1020 is capable of, configured to, or operable to support a means for outputting, for relay by the first UE, a WUS that includes the identifier associated with the second UE, where the WUS is modulated in accordance with an OOK modulation scheme.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced power consumption and more efficient utilization of communication resources.

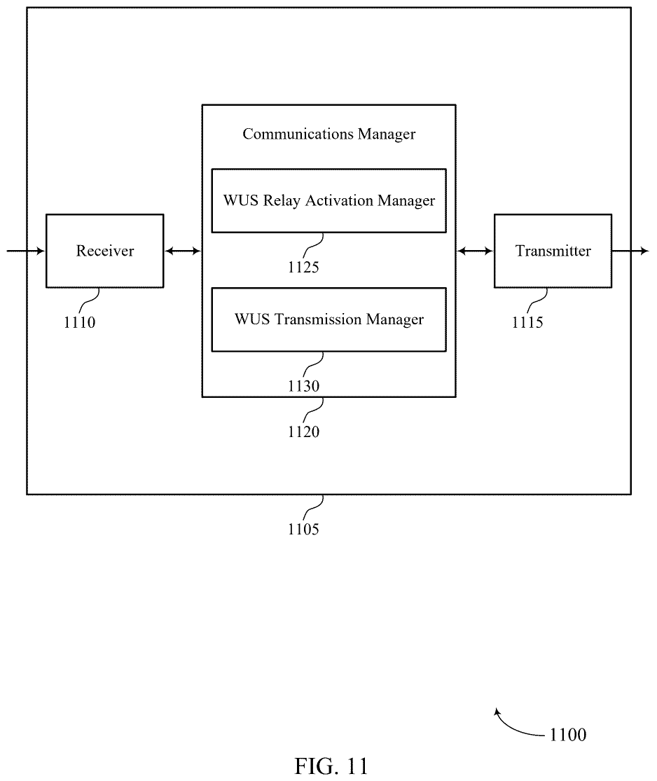

FIG. 11 shows a block diagram 1100 of a device 1105 that supports WUS range extension in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of WUS range extension as described herein. For example, the communications manager 1120 may include a WUS relay activation manager 1125 a WUS transmission manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The WUS relay activation manager 1125 is capable of, configured to, or operable to support a means for outputting, for a first UE, control signaling that indicates for the first UE to relay one or more WUSs that each include an identifier associated with a second UE. The WUS transmission manager 1130 is capable of, configured to, or operable to support a means for outputting, for relay by the first UE, a WUS that includes the identifier associated with the second UE, where the WUS is modulated in accordance with an OOK modulation scheme.

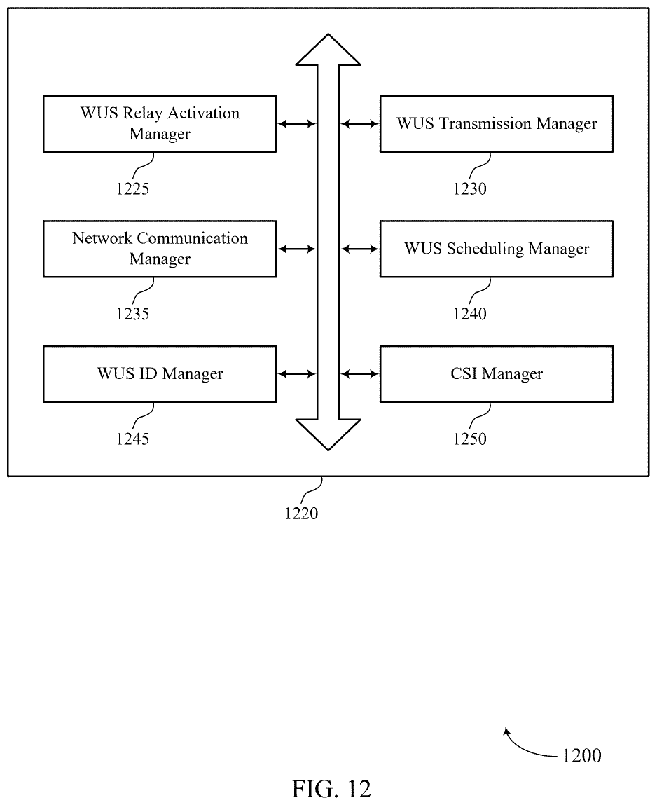

FIG. 12 shows a block diagram 1200 of a communications manager 1220 that supports WUS range extension in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of WUS range extension as described herein. For example, the communications manager 1220 may include a WUS relay activation manager 1225, a WUS transmission manager 1230, a network communication manager 1235, a WUS scheduling manager 1240, a WUS ID manager 1245, a CSI manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The WUS relay activation manager 1225 is capable of, configured to, or operable to support a means for outputting, for a first UE, control signaling that indicates for the first UE to relay one or more WUSs that each include an identifier associated with a second UE. The WUS transmission manager 1230 is capable of, configured to, or operable to support a means for outputting, for relay by the first UE, a WUS that includes the identifier associated with the second UE, where the WUS is modulated in accordance with an OOK modulation scheme.

In some examples, the network communication manager 1235 is capable of, configured to, or operable to support a means for performing a communication with the second UE based on outputting the WUS.

In some examples, to support performing the communication, the network communication manager 1235 is capable of, configured to, or operable to support a means for outputting a physical downlink control channel communication for the second UE.

In some examples, the WUS scheduling manager 1240 is capable of, configured to, or operable to support a means for outputting, for the first UE, first scheduling information for a first set of WUS monitoring occasions and a set of WUS relay occasions, where the WUS is output via a WUS monitoring occasion of the first set of WUS monitoring occasions. In some examples, the WUS scheduling manager 1240 is capable of, configured to, or operable to support a means for outputting, for the second UE, second scheduling information for a second set of WUS monitoring occasions that correspond to the set of WUS relay occasions.

In some examples, the WUS transmission manager 1230 is capable of, configured to, or operable to support a means for outputting, via a second WUS monitoring occasion of the first set of WUS monitoring occasions, a second WUS that includes a second identifier for the first UE, where the second WUS is modulated in accordance with the OOK modulation scheme. In some examples, the network communication manager 1235 is capable of, configured to, or operable to support a means for performing a communication with the first UE based on outputting of the second WUS.

In some examples, the WUS ID manager 1245 is capable of, configured to, or operable to support a means for outputting, for the first UE and prior to outputting of the second WUS, an indication of the second identifier associated with the first UE.

In some examples, the first scheduling information indicates a mapping between the first set of WUS monitoring occasions and the set of WUS relay occasions.

In some examples, the WUS ID manager 1245 is capable of, configured to, or operable to support a means for outputting, for the second UE and prior to outputting of the WUS, an indication of the identifier associated with the second UE.

In some examples, the CSI manager 1250 is capable of, configured to, or operable to support a means for outputting a first set of CSI-RSs for the first UE. In some examples, the CSI manager 1250 is capable of, configured to, or operable to support a means for obtaining a first CSI report associated with the first UE based on the first set of CSI-RSs. In some examples, the CSI manager 1250 is capable of, configured to, or operable to support a means for outputting a second set of CSI-RSs for the second UE. In some examples, the CSI manager 1250 is capable of, configured to, or operable to support a means for obtaining a second CSI report associated with the second UE based on the second set of CSI-RSs, where outputting the control signaling is based on the first CSI report and the second CSI report.

In some examples, the OOK modulation scheme is one of OOK type one or OOK type four.

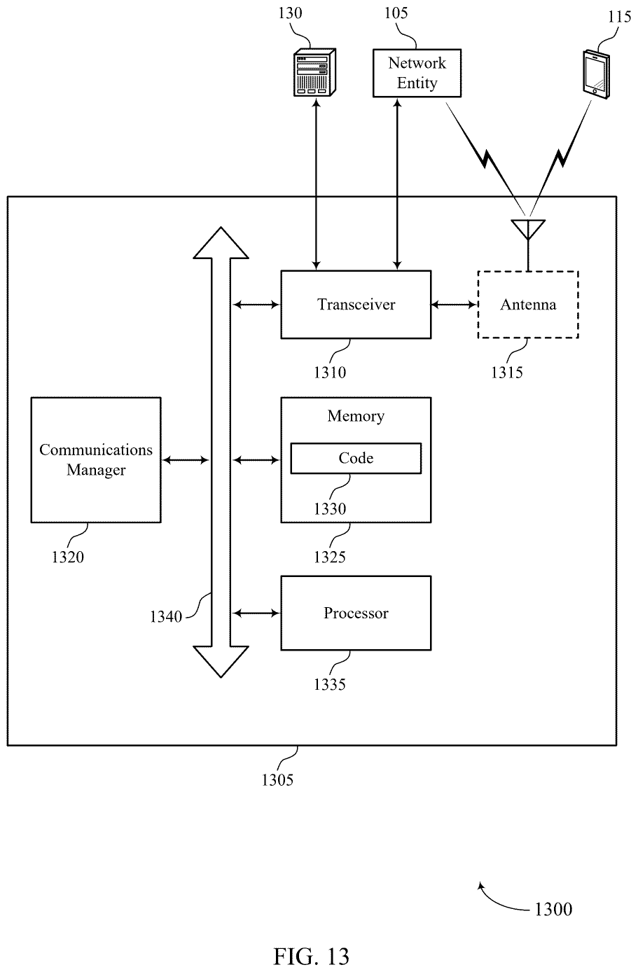

FIG. 13 shows a diagram of a system 1300 including a device 1305 that supports WUS range extension in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting WUS range extension). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, for a first UE, control signaling that indicates for the first UE to relay one or more WUSs that each include an identifier associated with a second UE. The communications manager 1320 is capable of, configured to, or operable to support a means for outputting, for relay by the first UE, a WUS that includes the identifier associated with the second UE, where the WUS is modulated in accordance with an OOK modulation scheme.

By including or configuring the communications manager 1320 in accordance with examples as described herein, the device 1305 may support techniques for reduced latency, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of WUS range extension as described herein, or the at least one processor 1335 and the at least one memory 1325 may be otherwise configured to, individually or collectively, perform or support such operations.

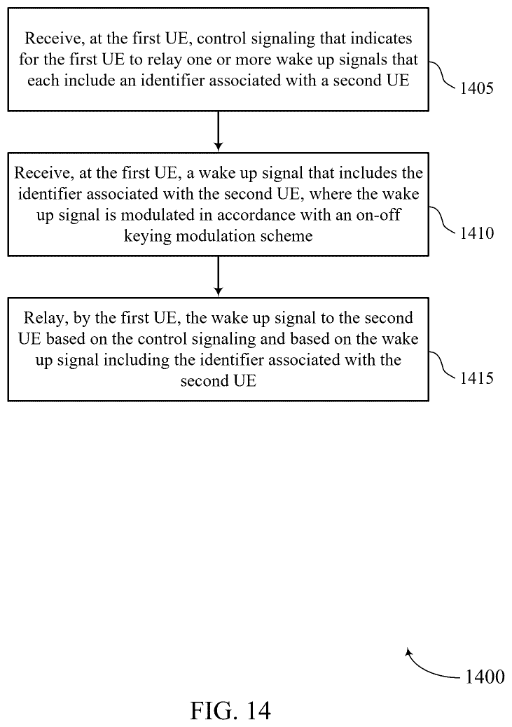

FIG. 14 shows a flowchart illustrating a method 1400 that supports WUS range extension in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, at the first UE, control signaling that indicates for the first UE to relay one or more WUSs that each include an identifier associated with a second UE. The operations of 1405 may be performed in accordance with examples as disclosed herein. In some examples, aspects of the operations of 1405 may be performed by a WUS relay activation manager 825 as described with reference to FIG. 8. Additionally, or alternatively, means for performing 1405 may, but not necessarily, include, for example, antenna 925, transceiver 915, communications manager 920, memory 930 (including code 935), processor 940 and/or bus 945.

At 1410, the method may include receiving, at the first UE, a WUS that includes the identifier associated with the second UE, where the WUS is modulated in accordance with an OOK modulation scheme. The operations of 1410 may be performed in accordance with examples as disclosed herein. In some examples, aspects of the operations of 1410 may be performed by a WUS monitoring manager 830 as described with reference to FIG. 8. Additionally, or alternatively, means for performing 1410 may, but not necessarily, include, for example, antenna 925, transceiver 915, communications manager 920, memory 930 (including code 935), processor 940 and/or bus 945.

At 1415, the method may include relaying, by the first UE, the WUS to the second UE based on the control signaling and based on the WUS including the identifier associated with the second UE. The operations of 1415 may be performed in accordance with examples as disclosed herein. In some examples, aspects of the operations of 1415 may be performed by a WUS relay manager 835 as described with reference to FIG. 8. Additionally, or alternatively, means for performing 1415 may, but not necessarily, include, for example, antenna 925, transceiver 915, communications manager 920, memory 930 (including code 935), processor 940 and/or bus 945.

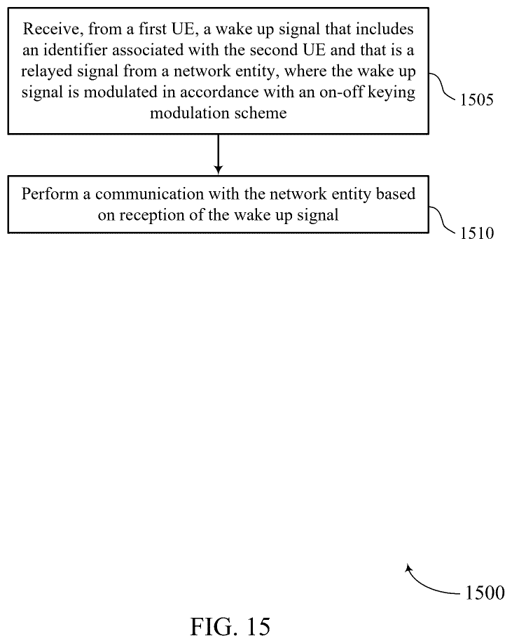

FIG. 15 shows a flowchart illustrating a method 1500 that supports WUS range extension in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a first UE, a WUS that includes an identifier associated with the second UE and that is a relayed signal from a network entity, where the WUS is modulated in accordance with an OOK modulation scheme. The operations of 1505 may be performed in accordance with examples as disclosed herein. In some examples, aspects of the operations of 1505 may be performed by a WUS monitoring manager 830 as described with reference to FIG. 8. Additionally, or alternatively, means for performing 1505 may, but not necessarily, include, for example, antenna 925, transceiver 915, communications manager 920, memory 930 (including code 935), processor 940 and/or bus 945.

At 1510, the method may include performing a communication with the network entity based on reception of the WUS. The operations of 1510 may be performed in accordance with examples as disclosed herein. In some examples, aspects of the operations of 1510 may be performed by a network communication manager 840 as described with reference to FIG. 8. Additionally, or alternatively, means for performing 1510 may, but not necessarily, include, for example, antenna 925, transceiver 915, communications manager 920, memory 930 (including code 935), processor 940 and/or bus 945.

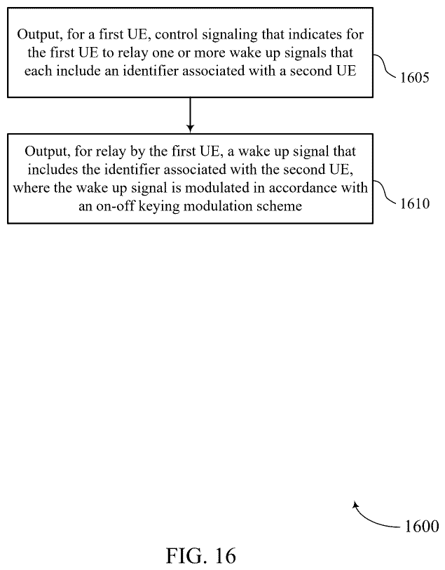

FIG. 16 shows a flowchart illustrating a method 1600 that supports WUS range extension in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting, for a first UE, control signaling that indicates for the first UE to relay one or more WUSs that each include an identifier associated with a second UE. The operations of 1605 may be performed in accordance with examples as disclosed herein. In some examples, aspects of the operations of 1605 may be performed by a WUS relay activation manager 1225 as described with reference to FIG. 12. Additionally, or alternatively, means for performing 1610 may, but not necessarily, include, for example, antenna 1315, transceiver 1310, communications manager 1320, memory 1325 (including code 1330), processor 1335 and/or bus 1340.

At 1610, the method may include outputting, for relay by the first UE, a WUS that includes the identifier associated with the second UE, where the WUS is modulated in accordance with an OOK modulation scheme. The operations of 1610 may be performed in accordance with examples as disclosed herein. In some examples, aspects of the operations of 1610 may be performed by a WUS transmission manager 1230 as described with reference to FIG. 12.

The following provides an overview of aspects of the present disclosure:
Aspect 1: A method for wireless communications at a first UE, comprising: receiving, at the first UE, control signaling that indicates for the first UE to relay one or more WUSs that each include an identifier associated with a second UE; receiving, at the first UE, a WUS that includes the identifier associated with the second UE, wherein the WUS is modulated in accordance with an OOK modulation scheme; and relaying, by the first UE, the WUS to the second UE based at least in part on the control signaling and based at least in part on the WUS including the identifier associated with the second UE.
Aspect 2: The method of aspect 1, wherein the first UE receives the WUS and relays the WUS via a secondary transceiver of the first UE while a primary transceiver of the first UE is in a sleep mode.
Aspect 3: The method of any of aspects 1 through 2, further comprising: receiving, from a network entity, scheduling information for a set of WUS monitoring occasions and a set of WUS relay occasions, wherein the WUS is received via a WUS monitoring occasion of the set of WUS monitoring occasions, and wherein the WUS is relayed via a WUS relay occasion of the set of WUS relay occasions.
Aspect 4: The method of aspect 3, further comprising: receiving, via a second WUS monitoring occasion of the set of WUS monitoring occasions, a second WUS that includes a second identifier associated with the first UE, wherein the second WUS is modulated in accordance with the OOK modulation scheme; and performing a communication with the network entity based at least in part on reception of the second WUS.
Aspect 5: The method of aspect 4, further comprising: receiving, prior to the reception of the second WUS, an indication of the second identifier associated with the first UE.
Aspect 6: The method of any of aspects 4 through 5, wherein the first UE receives the second WUS via a secondary transceiver of the second UE while a primary transceiver of the first UE is in a sleep mode, the method further comprising: transitioning the primary transceiver to an active mode based at least in part on the reception of the WUS, wherein the communication is performed via the primary transceiver.
Aspect 7: The method of any of aspects 3 through 6, wherein the scheduling information indicates a mapping between the set of WUS monitoring occasions and the set of WUS relay occasions.
Aspect 8: The method of any of aspects 1 through 7, wherein the OOK modulation scheme is one of OOK type one or OOK type four.
Aspect 9: The method of any of aspects 1 through 8, further comprising: receiving a set of CSI-RSs; and transmitting a CSI report based on one or more measurements of the set of CSI-RSs, wherein reception of the control signaling is based at least in part on the CSI report.
Aspect 10: A method for wireless communications at a second UE, comprising: receiving, from a first UE, a WUS that includes an identifier associated with the second UE and that is a relayed signal from a network entity, wherein the WUS is modulated in accordance with an OOK modulation scheme; and performing a communication with the network entity based at least in part on reception of the WUS.
Aspect 11: The method of aspect 10, wherein the second UE receives the WUS via a secondary transceiver of the second UE while a primary transceiver of the second UE is in a sleep mode, the method further comprising: transitioning the primary transceiver to an active mode based at least in part on the reception of the WUS, wherein the communication is performed via the primary transceiver.
Aspect 12: The method of any of aspects 10 through 11, further comprising: receiving, from the network entity prior to the reception of the WUS, an indication of the identifier for the second UE.
Aspect 13: The method of any of aspects 10 through 12, wherein performing the communication with the network entity comprises: receiving a physical downlink control channel communication.
Aspect 14: The method of any of aspects 10 through 13, further comprising: receiving, from the network entity, scheduling information for a set of WUS monitoring occasions, wherein the WUS is received via a WUS monitoring occasion of the set of WUS monitoring occasions.
Aspect 15: The method of any of aspects 10 through 14, further comprising: receiving a set of CSI-RSs; and transmitting a CSI report based on one or more measurements of the set of CSI-RSs, wherein the reception of the WUS from the first UE is based at least in part on the CSI report.
Aspect 16: The method of any of aspects 10 through 15, wherein the OOK modulation scheme is one of OOK type one or OOK type four.
Aspect 17: A method for wireless communications at a network entity, comprising: outputting, for a first UE, control signaling that indicates for the first UE to relay one or more WUSs that each include an identifier associated with a second UE; and outputting, for relay by the first UE, a WUS that includes the identifier associated with the second UE, wherein the WUS is modulated in accordance with an OOK modulation scheme.
Aspect 18: The method of aspect 17, further comprising: performing a communication with the second UE based at least in part on outputting the WUS.
Aspect 19: The method of aspect 18, wherein performing the communication comprises: outputting a physical downlink control channel communication for the second UE.
Aspect 20: The method of any of aspects 17 through 19, further comprising: outputting, for the first UE, first scheduling information for a first set of WUS monitoring occasions and a set of WUS relay occasions, wherein the WUS is output via a WUS monitoring occasion of the first set of WUS monitoring occasions; and outputting, for the second UE, second scheduling information for a second set of monitoring occasions that correspond to the set of WUS relay occasions.
Aspect 21: The method of aspect 20, further comprising: outputting, via a second WUS monitoring occasion of the first set of WUS monitoring occasions, a second WUS that includes a second identifier for the first UE, wherein the second WUS is modulated in accordance with the OOK modulation scheme; and performing a communication with the first UE based at least in part on outputting of the second WUS.
Aspect 22: The method of aspect 21, further comprising: outputting, for the first UE and prior to outputting of the second WUS, an indication of the second identifier associated with the first UE.
Aspect 23: The method of any of aspects 20 through 22, wherein the first scheduling information indicates a mapping between the first set of WUS monitoring occasions and the set of WUS relay occasions.
Aspect 24: The method of any of aspects 17 through 23, further comprising: outputting, for the second UE and prior to outputting of the WUS, an indication of the identifier associated with the second UE.
Aspect 25: The method of any of aspects 17 through 24, further comprising: outputting a first set of CSI-RSs for the first UE; obtaining a first CSI report associated with the first UE based at least in part on the first set of CSI-RSs; outputting a second set of CSI-RSs for the second UE; and obtaining a second CSI report associated with the second UE based at least in part on the second set of CSI-RSs, wherein outputting the control signaling is based at least in part on the first CSI report and the second CSI report.
Aspect 26: The method of any of aspects 17 through 25, wherein the OOK modulation scheme is one of OOK type one or OOK type four.
Aspect 27: A first UE for wireless communications, comprising one or more memories storing processor-executable code, one or more transceivers; and one or more processors coupled with the one or more memories and the one or more transceivers, the one or more processors configured to perform a method of any of aspects 1 through 9.
Aspect 28: A first UE for wireless communications, comprising at least one means for performing a method of any of aspects 1 through 9.
Aspect 29: A non-transitory computer-readable medium storing code for wireless communications, the code comprising instructions executable by one or more processors to perform a method of any of aspects 1 through 9.
Aspect 30: A second UE for wireless communications, comprising one or more memories storing processor-executable code, one or more transceivers; and one or more processors coupled with the one or more memories and the one or more transceivers, the one or more processors configured to perform a method of any of aspects 10 through 16.
Aspect 31: A second UE for wireless communications, comprising at least one means for performing a method of any of aspects 10 through 16.
Aspect 32: A non-transitory computer-readable medium storing code for wireless communications, the code comprising instructions executable by one or more processors to perform a method of any of aspects 10 through 16.
Aspect 33: A network entity for wireless communications, comprising one or more memories storing processor-executable code, and one or more processors coupled with the one or more memories, the one or more processors configured to perform a method of any of aspects 17 through 26.
Aspect 34: A network entity for wireless communications, comprising at least one means for performing a method of any of aspects 17 through 26.
Aspect 35: A non-transitory computer-readable medium storing code for wireless communications, the code comprising instructions executable by one or more processors to perform a method of any of aspects 17 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code;
one or more transceivers; and
one or more processors coupled with the one or more memories and the one or more transceivers, the one or more processors configured to:
receive, at the first UE and via the one or more transceivers, control signaling that indicates for the first UE to relay one or more wake up signals that each include an identifier associated with a second UE;
receive, at the first UE and via the one or more transceivers, a wake up signal that includes the identifier associated with the second UE, wherein the wake up signal is modulated in accordance with an on-off keying modulation scheme; and
relay, by the first UE and via the one or more transceivers, the wake up signal to the second UE based at least in part on the control signaling and based at least in part on the wake up signal including the identifier associated with the second UE.

2. The first UE of claim 1, wherein the one or more transceivers of the first UE comprise a primary transceiver and a secondary transceiver, and wherein the one or more processors are configured to receive the wake up signal and to relay the wake up signal via the secondary transceiver of the first UE while the primary transceiver of the first UE is in a sleep mode.

3. The first UE of claim 1, wherein the one or more processors are further configured to:
receive, from a network entity and via the one or more transceivers, scheduling information for a set of wake up signal monitoring occasions and a set of wake up signal relay occasions;
receive the wake up signal via a wake up signal monitoring occasion of the set of wake up signal monitoring occasions; and
relay the wake up signal via a wake up signal relay occasion of the set of wake up signal relay occasions.

4. The first UE of claim 3, wherein the one or more processors are configured to:
receive, via a second wake up signal monitoring occasion of the set of wake up signal monitoring occasions and via the one or more transceivers, a second wake up signal that includes a second identifier associated with the first UE, wherein the second wake up signal is modulated in accordance with the on-off keying modulation scheme; and
perform, via the one or more transceivers, a communication with the network entity based at least in part on reception of the second wake up signal.

5. The first UE of claim 4, wherein the one or more processors are configured to:
receive, prior to the reception of the second wake up signal and via the one or more transceivers, an indication of the second identifier associated with the first UE.

6. The first UE of claim 4, wherein the one or more transceivers of the first UE comprise a primary transceiver and a secondary transceiver, and wherein the one or more processors are configured to:
receive the second wake up signal via the secondary transceiver of the first UE while the primary transceiver of the first UE is in a sleep mode;
transition the primary transceiver to an active mode based at least in part on the reception of the wake up signal; and
perform the communication via the primary transceiver.

7. The first UE of claim 3, wherein the scheduling information indicates a mapping between the set of wake up signal monitoring occasions and the set of wake up signal relay occasions.

8. The first UE of claim 1, wherein:
the on-off keying modulation scheme is one of on-off keying type one or on-off keying type four.

9. The first UE of claim 1, wherein the one or more processors are configured to:
receive, via the one or more transceivers, a set of channel state information reference signals; and
transmit, via the one or more transceivers, a channel state information report based on one or more measurements of the set of channel state information reference signals, wherein the one or more processors are configured to receive the control signaling based at least in part on the channel state information report.

10. A second user equipment (UE), comprising:
one or more memories storing processor-executable code;
one or more transceivers; and
one or more processors coupled with the one or more memories and the one or more transceivers, the one or more processors configured to:
receive, from a first UE and via the one or more transceivers, a wake up signal that includes an identifier associated with the second UE and that is a relayed signal from a network entity, wherein the wake up signal is modulated in accordance with an on-off keying modulation scheme; and
perform, via the one or more transceivers, a communication with the network entity based at least in part on reception of the wake up signal.

11. The second UE of claim 10, wherein the one or more transceivers of the second UE comprise a primary transceiver and a secondary transceiver, and wherein the one or more processors are configured to:
receive the wake up signal via the secondary transceiver of the second UE while the primary transceiver of the second UE is in a sleep mode;:
transition the primary transceiver to an active mode based at least in part on the reception of the wake up signal; and
perform the communication via the primary transceiver.

12. The second UE of claim 10, wherein the one or more processors are configured to:
receive, from the network entity prior to the reception of the wake up signal and via the one or more transceivers, an indication of the identifier for the second UE.

13. The second UE of claim 10, wherein, to perform the communication with the network entity, the one or more processors are configured to:
receive, via the one or more transceivers, a physical downlink control channel communication.

14. The second UE of claim 10, wherein the one or more processors are configured to:
receive, from the network entity and via the one or more transceivers, scheduling information for a set of wake up signal monitoring occasions; and
receive the wake up signal via a wake up signal monitoring occasion of the set of wake up signal monitoring occasions.

15. The second UE of claim 10, wherein the one or more processors are configured to:
receive, via the one or more transceivers, a set of channel state information reference signals; and
transmit, via the one or more transceivers, a channel state information report based on one or more measurements of the set of channel state information reference signals, wherein the one or more processors are configured to receive the wake up signal from the first UE based at least in part on the channel state information report.

16. The second UE of claim 10, wherein:
the on-off keying modulation scheme is one of on-off keying type one or on-off keying type four.

17. A network entity, comprising:
one or more memories storing processor-executable code; and
one or more processors coupled with the one or more memories, the one or more processors configured to:
output, for a first UE, control signaling that indicates for the first UE to relay one or more wake up signals that each include an identifier associated with a second UE; and
output, for relay by the first UE, a wake up signal that includes the identifier associated with the second UE, wherein the one or more processors are configured to modulate the wake up signal in accordance with an on-off keying modulation scheme.

18. The network entity of claim 17, wherein the one or more processors are configured to:
output a physical downlink control channel communication for the second UE.

19. The network entity of claim 17, wherein the one or more processors are configured to:
output, for the first UE, first scheduling information for a first set of wake up signal monitoring occasions and a set of wake up signal relay occasions, wherein the one or more processors are configured to output the wake up signal via a wake up signal monitoring occasion of the first set of wake up signal monitoring occasions, and wherein the first scheduling information indicates a mapping between the first set of wake up signal monitoring occasions and the set of wake up signal relay occasions; and
output, for the second UE, second scheduling information for a second set of wake up signal monitoring occasions that correspond to the set of wake up signal relay occasions.

20. The network entity of claim 19, wherein the one or more processors are configured to:
output, for the first UE, an indication of a second identifier associated with the first UE;
output, via a second wake up signal monitoring occasion of the first set of wake up signal monitoring occasions and after outputting the indication of the second identifier associated with the first UE, a second wake up signal that includes the second identifier for the first UE, wherein the one or more processors are configured to modulate the wake up signal in accordance with the on-off keying modulation scheme; and
perform a communication with the first UE based at least in part on outputting the second wake up signal.
